(19) United States
(12) Patent Application Publication
(10) Pub. No.: US 2018/0303143 A1
(43) Pub. Date: Oct. 25, 2018

(54) TASTE QUALITY IMPROVING AGENT

(71) Applicant: AJINOMOTO CO., INC., Tokyo (JP)

(72) Inventor: Jo Taguchi, Kawasaki-shi (JP)

(73) Assignee: AJINOMOTO CO., INC., Tokyo (JP)

(21) Appl. No.: 15/958,450

(22) Filed: Apr. 20, 2018

(30) Foreign Application Priority Data
Apr. 21, 2017 (JP) 2017-084467

(51) Int. Cl. A23L 27/00; A23L 27/21; A23L 29/00

(52) U.S. Cl. CPC A23L 27/88; A23L 27/84; A23V 2200/16; A23L 29/045; A23V 2002/00; A23L 27/21

(57) ABSTRACT

N-[N-[3-(3-hydroxy-4-methoxyphenyl)propyl]-L-α-aspartyl]-L-phenylalanine is useful for improving the taste quality of a food, drink or pharmaceutical product.

### CROSS REFERENCES TO RELATED APPLICATIONS

This application claims priority to Japanese Patent Application No. 2017-084467, filed on Apr. 21, 2017, which is incorporated herein by reference in its entirety.

### BACKGROUND OF THE INVENTION

### Field of the Invention

The present invention relates to taste quality improving agents, method for improving taste quality, and the like.

### Discussion of the Background

For various reasons such as diversification and sophistication of consumer preferences, increases in health consciousness of consumers, or requests for masking off-tastes of pharmaceutical products and health foods, the development of a means capable of improving taste quality such as flavor and taste of foods, drinks and pharmaceutical products is desired.

For example, JP-B-5000770, which is incorporated herein by reference in its entirety, reports a Japanese horse-radish flavor enhancing agent using 3-methyl-γ-decalactone, 3-methyl-2-butene-1-thiol, trans-4,5-epoxy-(E)-2-decenal and the like. JP-B-5932890, which is incorporated herein by reference in its entirety, reports an apple flavor enhancing method including adding sinensal and/or nootkatone. Furthermore, JP-B-5162475, which is incorporated herein by reference in its entirety, reports a method of suppressing a bitter taste of pioglitazone by using alkali metal chloride.

However, a need remains for improved agents and methods for improving taste.

### SUMMARY OF THE INVENTION

Accordingly, it is one object of the present invention to provide novel taste quality improving agents capable of satisfying the above-mentioned needs.

It is another object of the present invention to provide novel methods for improving taste quality and the like, capable of satisfying the above-mentioned needs.

It is another object of the present invention to provide novel foods with an improved taste quality by adding such a taste quality improving agent.

These and other objects, which will become apparent during the following detailed description, have been achieved by the inventors' discovery that N-[N-[3-(3-hydroxy-4-methoxyphenyl)propyl]-L-α-aspartyl]-L-phenylalanine concurrently has an off taste masking function and a flavor enhancing function.

Accordingly, the present invention provides the following:

(1) An agent for improving taste quality of a food, drink, or pharmaceutical product, comprising N-[N-[3-(3-hydroxy-4-methoxyphenyl)propyl]-L-α-aspartyl]-L-phenylalanine.

(2) The taste quality improving agent of (1), wherein the taste quality improvement comprises one or more selected from the group consisting of masking of an off taste and enhancement of a flavor.

(3) A method for improving taste quality of a food, drink or pharmaceutical product, comprising adding N-[N-[3-(3-hydroxy-4-methoxyphenyl)propyl]-L-α-aspartyl]-L-phenylalanine.

(4) The method of (3), wherein the taste quality improvement comprises one or more selected from the group consisting of masking of an off taste and enhancement of a flavor.

(5) The method of (3) or (4), wherein the aforementioned N-[N-[3-(3-hydroxy-4-methoxyphenyl)propyl]-L-α-aspartyl]-L-phenylalanine is added at 0.001 weight ppm to 100 weight ppm.

(6) A method for producing a food, drink or pharmaceutical product, comprising adding N-[N-[3-(3-hydroxy-4-methoxyphenyl)propyl]-L-α-aspartyl]-L-phenylalanine.

(7) The method of (6), wherein the aforementioned N-[N-[3-(3-hydroxy-4-methoxyphenyl)propyl]-L-α-aspartyl]-L-phenylalanine is added at 0.001 weight ppm to 100 weight ppm.

(8) A food, drink or pharmaceutical product comprising N-[N-[3-(3-hydroxy-4-methoxyphenyl)propyl]-L-α-aspartyl]-L-phenylalanine at 0.001 weight ppm to 100 weight ppm.

### Effect of the Invention

According to the present invention, off tastes such as bitter taste, astringent taste, harsh taste and the like of foods, drinks and/or pharmaceutical products can be masked and various flavors of various foods and drinks can be enhanced.

### DETAILED DESCRIPTION OF THE INVENTION

The present invention is explained in detail in the following.

### 1. Taste Quality Improving Agent for Food, Drink or Pharmaceutical Product

The present invention provides a taste quality improving agent for foods, drinks and pharmaceutical products, which contains N-[N-[3-(3-hydroxy-4-methoxyphenyl)propyl]-L-α-aspartyl]-L-phenylalanine (hereinafter sometimes to be simply referred to as “the taste quality improving agent of the present invention”). By adding the taste quality improving agent of the present invention to foods, drinks and pharmaceutical products, the flavor of the foods, drinks and pharmaceutical products can be enhanced and off tastes of them can be suppressed.

N-[N-[3-(3-hydroxy-4-methoxyphenyl)propyl]-L-α-aspartyl]-L-phenylalanine (CAS number: 713524-95-9) is a white to yellow powder at ambient temperature and does not have sweetness. The compound can be synthesized by a method known per se, and a commercially available product may also be used.

The content of the compound in the taste quality improving agent of the present invention is not particularly limited as long as the desired effect can be obtained and can be appropriately set within the range greater than 0 wt % and not more than 100 wt %. It is generally 0.001 wt % to 99.999 wt %, preferably, 0.01 wt % to 99.99 wt %, more preferably 0.1 wt % to 99.9 wt %, based on the total weight of the taste quality improving agent.

The form of the taste quality improving agent of the present invention is not particularly limited as long as the desired effect can be obtained and can be prepared as a form of, for example, a solid such as powder, granule and the like, a liquid, a paste or the like.

The taste quality improving agent of the present invention can contain a component other than N-[N-[3-(3-hydroxy-4-methoxyphenyl)propyl]-L-α-aspartyl]-L-phenylalanine as long as the desired effect can be obtained. Examples of the component that can be added to the taste quality improving agent of the present invention include, but are not limited to, dextrin, lactose, a sugar alcohol, and the like.

Examples of the taste quality that can be improved by applying the taste quality improving agent of the present invention include, but are not limited to, masking of an off taste and enhancement of a flavor. Examples of the off taste that can be masked by applying the taste quality improving agent of the present invention include, but are not limited to, bitter taste, sour taste, harsh taste, rough taste, metal taste, sweetness, salty taste, astringent taste and the like. Examples of the flavor that can be enhanced by applying the taste quality improving agent of the present invention include, but are not limited to, vanilla flavor, caramel flavor, citrus related flavor, chocolate flavor, berry related flavor, chili flavor, cola flavor, mint flavor, milk flavor, garlic flavor, cheese flavor, grape flavor, banana flavor, pineapple flavor, melon flavor, mango flavor, pumpkin flavor, brown sugar lump flavor, onion flavor, black pepper flavor, soy sauce flavor, miso flavor, pork bone flavor, tomato flavor, meat flavor, coffee flavor, cocoa flavor, peach flavor, tea flavor, peanut flavor, caramel flavor, egg flavor and the like.

Examples of the target substance of the taste quality that can be enhanced by applying the taste quality improving agent of the present invention include, but are not limited to, an amino acid such as leucine, isoleucine, valine, arginine, and the like; an alkaloid such as caffeine, theobromine, humulone, and the like; polyphenol; an organic acid such as acetic acid, citric acid, lactic acid, and the like; a peptide such as whey peptide and the like; a protein such as whey protein and the like.

### 2. Method for Improving Taste Quality of Food, Drink or Pharmaceutical Product

In another embodiment, the present invention provides a method for improving taste quality of foods, drinks and pharmaceutical products, comprising adding N-[N-[3-(3-hydroxy-4-methoxyphenyl)propyl]-L-α-aspartyl]-L-phenylalanine (hereinafter sometimes to be simply referred to as “the method for improving taste quality of the present invention”).

N-[N-[3-(3-hydroxy-4-methoxyphenyl)propyl]-L-α-aspartyl]-L-phenylalanine used for the method for improving taste quality of the present invention and the taste quality and target substance to be improved are similar to those for the aforementioned taste quality improving agent of the present invention.

The amount of N-[N-[3-(3-hydroxy-4-methoxyphenyl)propyl]-L-α-aspartyl]-L-phenylalanine to be added to a food, drink or pharmaceutical product in the method for improving taste quality of the present invention is not particularly limited as long as the desired effect can be obtained. It may be generally 0.001 weight ppm to 100 weight ppm, preferably 0.01 weight ppm to 10 weight ppm, more preferably 0.4 weight ppm to 10 weight ppm, based on the total weight of the food, drink, or pharmaceutical product.

In the method for improving taste quality of the present invention, the timing of addition of N-[N-[3-(3-hydroxy-4-methoxyphenyl)propyl]-L-α-aspartyl]-L-phenylalanine to a food, drink or pharmaceutical product is not particularly limited as long as the desired effect can be obtained. In the case of foods and drinks, it may be any of before cooking, during cooking, after cooking and during eating or drinking. In the case of pharmaceutical products, for example, the compound is preferably added during production of the pharmaceutical product, but the timing is not limited thereto.

In the method for improving taste quality of the present invention, N-[N-[3-(3-hydroxy-4-methoxyphenyl)propyl]-L-α-aspartyl]-L-phenylalanine may be added in advance to foods, drinks or pharmaceutical products at the above-mentioned timing, or the components may be prepared in advance such that the compound would be finally contained in the food, drink or pharmaceutical product at a desired concentration, assuming chemical reaction by heating during cooking, time-course decomposition and the like. Those of ordinary skill in the art can appropriately determine the necessary components and conditions.

### 3. Production Method of Food, Drink or Pharmaceutical Product

In another embodiment, the present invention provides a production method of food, drink or pharmaceutical product, which method includes adding N-[N-[3-(3-hydroxy-4-methoxyphenyl)propyl]-L-α-aspartyl]-L-phenylalanine (hereinafter sometimes to be simply referred to as “the production method of the present invention”). The food, drink or pharmaceutical product to be produced by the production method of the present invention has an enhanced flavor and/or masked off taste and shows good taste quality.

The taste quality and target substance that may be improved by N-[N-[3-(3-hydroxy-4-methoxyphenyl)propyl]-L-α-aspartyl]-L-phenylalanine used in the production method of the present invention are similar to those for the aforementioned taste quality improving agent of the present invention. The amount of the compound to be contained in the food, drink or pharmaceutical product, the timing of addition and the like in the production method of the present invention are the same as those described for the method for improving taste quality of the present invention.

While the kind of the food, drink or pharmaceutical product to be produced by the production method of the present invention is not particularly limited as long as the desired effect can be obtained, it is preferably a food, drink or pharmaceutical product having bitter taste, sour taste, harsh taste, rough taste, metal taste, sweetness, salty taste, astringent taste or the like, or a food, drink or pharmaceutical product having vanilla flavor, caramel flavor, citrus related flavor, chocolate flavor, berry related flavor, chili flavor, cola flavor, mint flavor, milk flavor, garlic flavor, cheese flavor, grape flavor, banana flavor, pineapple flavor, melon flavor, mango flavor, pumpkin flavor, brown sugar lump flavor, onion flavor, black pepper flavor, soy sauce flavor, miso flavor, pork bone flavor, tomato flavor, meat flavor, coffee flavor, cocoa flavor, peach flavor, tea flavor, peanut flavor, caramel flavor, egg flavor or the like.

### 4. Food, Drink or Pharmaceutical Product

In another embodiment, the present invention provides a food, drink or pharmaceutical product containing N-[N-[3-(3-hydroxy-4-methoxyphenyl)propyl]-L-α-aspartyl]-L-phenylalanine at 0.001 weight ppm-100 weight ppm (hereinafter sometimes to be simply referred to as “the food, drink or pharmaceutical product of the present invention”).

The food, drink or pharmaceutical product of the present invention can be prepared by adding N-[N-[3-(3-hydroxy-4-methoxyphenyl)propyl]-L-α-aspartyl]-L-phenylalanine in advance to the food, drink or pharmaceutical product before cooking, during cooking, after cooking or during eating or drinking the food or drink, or during production of the pharmaceutical product. Alternatively, the components may be prepared in advance such that the compound would be finally contained in the food, drink or pharmaceutical product at a desired concentration, assuming chemical reaction by heating during cooking, time-course decomposition and the like. The desired concentration of the compound is generally 0.001 weight ppm to 100 weight ppm, preferably 0.01 weight ppm to 10 weight ppm, more preferably 0.4 weight ppm to 10 weight ppm, based on the total weight of the food, drink, or pharmaceutical product.

Other features of the invention will become apparent in the course of the following descriptions of exemplary embodiments which are given for illustration of the invention and are not intended to be limiting thereof.

### EXAMPLES

To study the taste quality improving function of N-[N-[3-(3-hydroxy-4-methoxyphenyl)propyl]-L-α-aspartyl]-L-phenylalanine, the present inventors added the compound to various foods and drinks and evaluated an off taste masking function and a flavor enhancing function. To be more specific, the off taste masking function was studied using the evaluation systems shown in Table 2 below, and the flavor enhancing function was studied using the evaluation systems shown in Table 3 below. N-[N-[3-(3-hydroxy-4-methoxyphenyl)propyl]-L-α-aspartyl]-L-phenylalanine was obtained from ZIEBEN CHEMICALS CO., LTD.

### Preparation of Evaluation System

Each food or drink to be the evaluation system was prepared in the amounts shown in the following Table 1. Since the amount of N-[N-[3-(3-hydroxy-4-methoxyphenyl)propyl]-L-α-aspartyl]-L-phenylalanine added was very small, the compound (0.01 g) was first weighed, and then diluted with 99.99 g of ion exchange water to give a 0.01% aqueous solution of the compound. The solution was subjected to the preparation of each evaluation system.

TABLE 1

| N-[N-[3-(3- | | | | | | |
|---|---|---|---|---|---|---|
| hydroxy-4- | | | | | | |
| methoxy- | | | | | | |
| phenyl) | | | | | | |
| propyl]-L-α- | | | | | | |
| aspartyl)-L- | | | | | | |
| phenylalanine | 0 ppm | 0.001 | 0.01 | 0.4 | 1.0 | 10 |
| concentration | (control) | ppm | ppm | ppm | ppm | ppm |
| base | 90.91 g | 90.91 g | 90.91 g | 90.91 g | 90.91 g | 90.91 g |
| (commercially | | | | | | |
| available | | | | | | |
| product or | | | | | | |
| experimental | | | | | | |
| preparation) | | | | | | |
| N-[N-[3-(3- | — | 0.0009 g | 0.009 g | 0.36 g | 0.91 g | 9.09 g |
| hydroxy-4- | | | | | | |
| methoxy- | | | | | | |
| phenyl) | | | | | | |
| propyl]-L- | | | | | | |
| α-aspartyl]- | | | | | | |
| L- | | | | | | |
| phenylalanine | | | | | | |
| 0.01% | | | | | | |
| aqueous, | | | | | | |
| solution | | | | | | |
| water | 9.09 g | 9.0891 g | 9.081 g | 8.73 g | 8.18 g | 0 |
| Total | 100 g | 100 g | 100 g | 100 g | 100 g | 100 g |

### Evaluation Method

The function of N-[N-[3-(3-hydroxy-4-methoxyphenyl)propyl]-L-α-aspartyl]-L-phenylalanine was evaluated by a sensory test by four professional panelists. For sensory test, various experimental preparations were fractionated by 20 g each in plastic cups, and both drinks and solids were evaluated by a spit-out method. Between evaluation and evaluation, the oral cavity was washed with ion exchange water. The evaluation criteria were as follows.

### Evaluation Criteria

−: no function is felt
+: function can be felt
++: function is clearly felt
+++: function is strongly felt

### Results

The evaluation results of the off taste masking function of N-[N-[3-(3-hydroxy-4-methoxyphenyl)propyl]-L-α-aspartyl]-L-phenylalanine are shown in Table 2. The evaluation results of the flavor enhancing function of the compound are shown in Table 3.

TABLE 2
Masking

| | | | | N-[N-[3-(3-hydroxy-4- | | | | | |
|---|---|---|---|---|---|---|---|---|---|
| | target | classifi- | | methoxyphenyl)propyl]-L-α-aspartyl]- | | | | | |
| classifi- | substance | cation | | L-phenylalanine concentration | | | | | |
| cation of | of off | of target | | 0 ppm | 0.001 | 0.01 | 0.4 | 1.0 | 10 |
| off taste | taste | substance | evaluation system | (control) | ppm | ppm | ppm | ppm | ppm |
| bitter | leucine | amino acid | leucine-containing soft drink | − | + | + | ++ | ++ | ++ |
| taste | | | with minute amounts of | | | | | | |
| | | | flavoring | | | | | | |
| | | | (experimental preparation) | | | | | | |
| | caffeine | alkaloid | sugar-free coffee (Ajinomoto | − | + | + | + | ++ | ++ |
| | | | AGF, Inc. “Blendy bottled | | | | | | |
| | | | coffee sugar-free”) | | | | | | |
| | polyphenol | polyphenol | polyphenol juice | − | + | + | ++ | +++ | +++ |
| | | | (Kagome Co., Ltd. “YASAI | | | | | | |
| | | | SEIKATSU 100 energy root”) | | | | | | |
| sour | acetic | organic | black vinegar drink | − | + | + | ++ | +++ | +++ |
| taste | acid | acid | (Tamanoi vinegar Co., Ltd. | | | | | | |
| | | | “Hachimitsu Kurosu diet”) | | | | | | |
| | citric | organic | 1.0% aqueous lemon juice | − | + | + | + | ++ | +++ |
| | acid | acid | solution | | | | | | |
| | lactic | organic | plain yogurt (Meiji Co., Ltd. | − | + | + | + | +++ | +++ |
| | acid | acid | “Bulgaria yogurt plain”) | | | | | | |
| harsh | whey | peptide | 1.0% aqueous supplement | − | + | + | + | ++ | ++ |
| taste | peptide | | solution (Meiji Co., Ltd. | | | | | | |
| | | | “SAVAS Power Aamino 2500”) | | | | | | |
| | whey | protein | 1.0% aqueous whey protein | − | + | + | ++ | ++ | +++ |
| | protein | | solution (DOME CORPORATION | | | | | | |
| | | | “DNS whey protein 100 vanilla | | | | | | |
| | | | flavor”) | | | | | | |

TABLE 3
Flavor enhancement

| | | N-[N-[3-(3-hydroxy-4-methoxyphenyl) | | | | | |
|---|---|---|---|---|---|---|---|
| | | propyl]-L-α-aspartyl]-L- | | | | | |
| | | phenylalanine concentration | | | | | |
| | | 0 ppm | 0.001 | 0.01 | 0.4 | 1.0 | 1.0 |
| flavor classification | evaluation system | (control) | ppm | ppm | ppm | ppm | ppm |
| vanilla | vanilla yogurt (Nipponluna. inc) | − | ++ | ++ | +++ | +++ | +++ |
| Caramel | Caramel latte (Seven-Eleven Japan | − | ++ | ++ | +++ | +++ | +++ |
| | Co., Ltd.) | | | | | | |
| citrus related | POM Juice | − | + | ++ | ++ | +++ | +++ |
| | (Ehime Beverage Inc.) | | | | | | |
| chocolate | chocolatecream | − | + | ++ | +++ | +++ | +++ |
| | (Seven-Eleven Japan Co., Ltd.) | | | | | | |
| berry related | Strawberry jam | − | + | + | ++ | ++ | +++ |
| | (AOHATA Corporation “Fully fruit | | | | | | |
| | Strawberry”) | | | | | | |
| cola | Coca-Cola | − | + | + | ++ | +++ | +++ |
| | (COCA-COLA JAPAN Co., Ltd.) | | | | | | |
| mint | mint flavor soft drink | − | + | + | ++ | +++ | +++ |
| | (experimental preparation) | | | | | | |

As shown in Table 2, N-[N-[3-(3-hydroxy-4-methoxyphenyl)propyl]-L-α-aspartyl]-L-phenylalanine could mask various kinds of off tastes. As shown in Table 3, the compound could also enhance various flavors. From the above, it was shown that N-[N-[3-(3-hydroxy-4-methoxyphenyl)propyl]-L-α-aspartyl]-L-phenylalanine provides a high taste quality improving effect with broad utility.

### INDUSTRIAL APPLICABILITY

According to the present invention, off tastes such as bitter taste, rough taste, harsh taste and the like of foods, drinks and pharmaceutical products can be masked and various flavors of various foods and drinks can be enhanced. Therefore, the present invention is highly useful in the fields of the production of foods and drinks and the production of pharmaceutical products.

Where a numerical limit or range is stated herein, the endpoints are included. Also, all values and subranges within a numerical limit or range are specifically included as if explicitly written out.

As used herein the words “a” and “an” and the like carry the meaning of “one or more.”

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. An agent for improving taste quality of a food, drink or pharmaceutical product, comprising N-[N-[3-(3-hydroxy-4-methoxyphenyl)propyl]-L-α-aspartyl]-L-phenylalanine.

2. A method for improving taste quality of a food, drink, or pharmaceutical product, comprising adding N-[N-[3-(3-hydroxy-4-methoxyphenyl)propyl]-L-α-aspartyl]-L-phenylalanine to a food, drink, or pharmaceutical product.

3. The method according to claim 2, wherein the improving taste quality comprises one or more selected from the group consisting of masking of an off taste and enhancement of a flavor.

4. The method according to claim 2, wherein said N-[N-[3-(3-hydroxy-4-methoxyphenyl)propyl]-L-α-aspartyl]-L-phenylalanine is added to said food, drink, or pharmaceutical product in an amount of 0.001 weight ppm to 100 weight ppm based on the weight of said food, drink, or pharmaceutical product.

5. The method according to claim 3, wherein said N-[N-[3-(3-hydroxy-4-methoxyphenyl)propyl]-L-α-aspartyl]-L-phenylalanine is added to said food, drink, or pharmaceutical product in an amount of 0.001 weight ppm to 100 weight ppm based on the weight of said food, drink, or pharmaceutical product.

6. A method for producing a food, drink or pharmaceutical product, comprising adding N-[N-[3-(3-hydroxy-4-methoxyphenyl)propyl]-L-α-aspartyl]-L-phenylalanine to a food, drink, or pharmaceutical product.

7. The method according to claim 6, wherein said N-[N-[3-(3-hydroxy-4-methoxyphenyl)propyl]-L-α-aspartyl]-L-phenylalanine is added to said food, drink, or pharmaceutical product in an amount of 0.001 weight ppm to 100 weight ppm based on the weight of said food, drink, or pharmaceutical product.

8. A food, drink, or pharmaceutical product, comprising. N-[N-[3-(3-hydroxy-4-methoxyphenyl)propyl]-L-α-aspartyl]-L-phenylalanine in an amount of 0.001 weight ppm to 100 weight ppm based on the weight of said food, drink, or pharmaceutical product.
